(19) United States
(12) Patent Application Publication
(10) Pub. No.: US 2023/0287899 A1
(43) Pub. Date: Sep. 14, 2023

(54) PUMP CASING AND PUMP APPARATUS

(71) Applicant: EBARA CORPORATION, Tokyo (JP)

(72) Inventors: Akinori MURATA, Tokyo (JP); Shuichiro HONDA, Tokyo (JP); Hiroyuki FUJISAWA, Tokyo (JP); Satoshi YAMAZAKI, Tokyo (JP)

(21) Appl. No.: 17/927,315

(22) PCT Filed: Apr. 20, 2021
(86) PCT No.: PCT/JP2021/016045

§ 371 Date: Mar. 3, 2023

(30) Foreign Application Priority Data
May 26, 2020 (JP) 2020-091475
Jan. 14, 2021 (JP) 2021-004159

(51) Int. Cl. F04D 29/42; F04D 13/06

(52) U.S. Cl. CPC F04D 29/4293; F04D 13/06

(57) ABSTRACT

The present invention relates to a pump casing and a pump apparatus. The pump casing (5) includes a suction nozzle (100) with formed a suction port (12). The suction nozzle (100) slopes downward toward the suction port (12).

### TECHNICAL FIELD

The present invention relates to a pump casing and a pump apparatus.

### BACKGROUND ART

A pump apparatus is known that includes a rotational shaft, an impeller fixed to the rotational shaft, a motor that rotates the impeller together with the rotational shaft, and a pump casing having a suction port and a discharge port and housing the impeller (see for example Patent Document 1).

When the motor is driven, the rotational shaft and impeller rotate. When the impeller rotates, a liquid flows through the suction port into the pump casing and is pressurized as the impeller rotates. The pressurized liquid is discharged from the discharge port.

### CITATION LIST

### Patent Literature

Patent document 1: Japanese laid-open patent publication No. 2017-96374
Patent document 2: Japanese laid-open patent publication No. 2017-89839

### SUMMARY OF INVENTION

### Technical Problem

Depending on the intended use, the pump apparatus is periodically disassembled and cleaned in order to maintain the quality of the liquid to be conveyed. When the pump is removed from a pipe and an inside of the pump casing is cleaned, it is necessary to completely remove a liquid remaining in the pump casing. When the removed pump is moved, there is a concern that the liquid remaining in the pump casing will contaminate the surroundings.

It is therefore an object of the present invention to provide a pump casing and a pump apparatus including the pump casing, which have a simple structure and can be easily cleaned in an internal flow path.

### Solution to Problem

In an embodiment, there is provided a pump casing having a suction port connected to a horizontally extending suction pipe, comprising: a suction nozzle with formed the suction port, and the suction nozzle sloping downward toward the suction port.

In an embodiment, the suction port is a bottom portion in the pump casing.

In an embodiment, the pump casing comprises a volute portion connecting to the suction nozzle, and the suction nozzle has a straight shape extending diagonally downward from the volute portion.

In an embodiment, the suction port is arranged below the volute portion, and a work space for connecting the suction nozzle to the suction pipe is formed between the volute portion and the suction nozzle.

In an embodiment, there is provided a pump casing having a suction port and a discharge port, comprising: a suction nozzle with formed the suction port, and the suction nozzle having a drain port at a bottom portion of the suction nozzle.

In an embodiment, there is provided a pump apparatus comprising: an impeller; a rotational shaft fixing to the impeller; a motor configured to rotate the rotational shaft; and a pump casing according to above described, the pump casing housing the impeller.

In an embodiment, the pump apparatus comprising a leg portion connected to the pump casing.

In an embodiment, the leg portion forms a space below a suction flange portion having the suction port, the space arranging a drain pan configured to catch a liquid discharged from the suction port.

In an embodiment, the pump casing comprises a suction nozzle with formed the suction port, the suction nozzle has a drain port at a bottom portion of the suction nozzle, and the leg portion forms a space below the drain port, the space arranging a drain pan configured to catch the liquid discharged from the suction port.

In an embodiment, the pump casing comprises a suction nozzle with formed the suction port, the suction nozzle has a drain port at a bottom portion of the suction nozzle, and the leg portion forms a space arranging a pipe connectable to the drain port.

In an embodiment, there is provided a pump apparatus comprising: an impeller; a rotational shaft fixing to the impeller; a motor configured to rotate the rotational shaft; and a pump casing housing the impeller, the motor comprises: a bearing configured to rotatably support the rotational shaft; a motor casing having a bearing support portion configured to support the bearing; and a bearing retainer configured to restrict a movement of the bearing in an axial direction of the rotational shaft.

In an embodiment, the bearing retainer is fixed to the bearing support portion.

In an embodiment, the bearing retainer has an annular shape.

In an embodiment, the pump apparatus is a vertical pump apparatus.

In an embodiment, there is provided a vertical pump apparatus comprising: an impeller; a rotational shaft fixing to the impeller; an impeller housing structure configured to house the impeller; and a gap adjustment structure configured to adjust a size of a gap between the impeller and the impeller housing structure.

In an embodiment, the gap adjustment structure comprises: a distance piece attached to a stepped portion of the rotational shaft; and at least one shim arranged between the distance piece and the impeller.

In an embodiment, there is provided a pump casing comprising: a suction nozzle having a suction port; and a volute portion connecting to the suction nozzle, and the suction nozzle slopes downward from a connection portion connected to the volute portion toward the suction port, and has a flow path whose cross-sectional area increases from the suction port to the connection portion.

In an embodiment, the suction nozzle has a wide portion arranged between the suction port and the connection portion.

In an embodiment, the wide portion extends horizontally.

In an embodiment, a cross-sectional area of the flow path increases at a constant rate of change from the suction port toward the connection portion.

In an embodiment, there is provided a pump casing comprising: a suction nozzle having a suction port; and a volute portion connected to a connection portion of the suction nozzle, and the volute portion having a volute chamber, a bottom surface of the volute chamber slopes downward from a peripheral portion of the volute chamber toward the connection portion.

In an embodiment, the suction nozzle slopes downward from the connection portion toward the suction port.

In an embodiment, the suction port is arranged at a position lower than a discharge port of the pump casing.

### Advantageous Effects of Invention

The pump casing includes a suction nozzle that can discharge an inside liquid at the bottom portion of the flow path of the pump casing. Therefore, the liquid in the pump casing is discharged outside from the suction nozzle by the action of gravity.

### BRIEF DESCRIPTION OF DRAWINGS

FIG. 1 is a view showing one embodiment of a pump apparatus;

FIG. 2 is a view for explaining an effect of a pump casing including a suction nozzle;

FIG. 3 is a view showing another embodiment of the pump apparatus;

FIG. 4 is a view seen from a direction of a line A in FIG. 3;

FIG. 5 is a view showing another embodiment of a suction flange portion;

FIG. 6 is a view showing another embodiment of the leg portion;

FIG. 7 is a view showing another embodiment of the suction nozzle;

FIG. 8 is a view showing one embodiment of a motor;

FIG. 9 is a view showing a bearing retainer;

FIG. 10 is a view showing a gap adjustment structure;

FIG. 11 is an enlarged view of the gap adjustment structure;

FIG. 12 is a view showing another embodiment of the pump apparatus;

FIG. 13 is a cross-sectional view taken along a line B-B of FIG. 12;

FIG. 14 is a view seen from a direction of a line C in FIG. 12; and

FIG. 15 is a view showing another embodiment of the pump casing.

### DESCRIPTION OF EMBODIMENTS

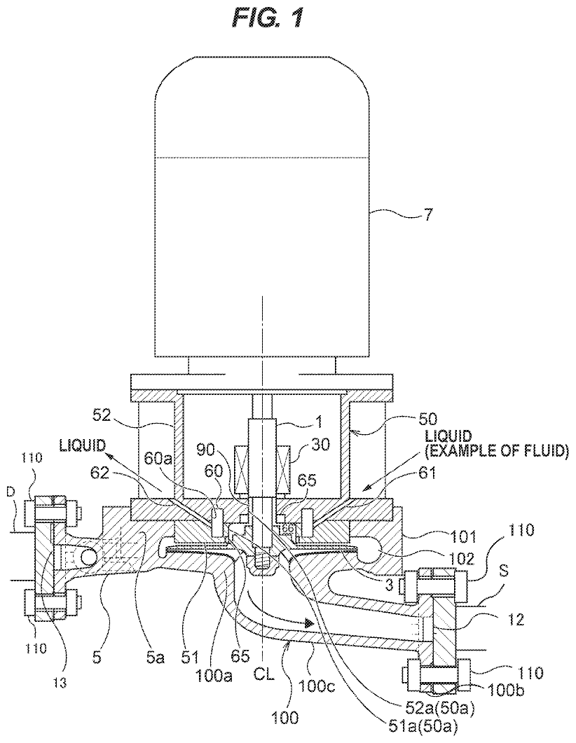

Embodiments of the present invention will be described with reference to the drawings. FIG. 1 is a view showing one embodiment of a pump apparatus. As shown in FIG. 1, the pump apparatus includes a rotational shaft 1 for pressurizing a liquid to be handled (transferred liquid), an impeller 3 fixed to the rotational shaft 1, a pump casing 5 housing the impeller 3, a motor 7 for rotating the rotational shaft 1, an intermediate bracket 50 arranged between the pump casing 5 and the motor 7, and a shaft sealing device 30 for preventing leakage of high-pressure liquid. The pump casing 5 includes a suction port 12 and a discharge port 13, and is made of a corrosion-resistant material (e.g., stainless steel). In the embodiment shown in FIG. 1, the rotational shaft 1 is arranged vertically (see a direction of an axis line CL in FIG. 1). The intermediate bracket 50 has an opening 50a through which the rotational shaft 1 penetrates, and the shaft sealing device 30 seals the transferred liquid leaking to the outside (i.e., the outside is the motor 7) from the opening 50a through which the rotational shaft 1 penetrates.

When the motor 7 is driven, a rotation of the motor 7 is transmitted to the rotational shaft 1, and the rotational shaft 1 and the impeller 3 rotate. When the impeller 3 rotates, the liquid flows into the pump casing 5 through the suction port 12, and is pressurized as the impeller 3 rotates. The pressurized liquid is discharged from the discharge port 13. In the embodiment shown in FIG. 1, the impeller 3 is a semi-open impeller. In one embodiment, the impeller 3 may be a vortex impeller or a closed impeller.

The shaft sealing device 30 is a device that seals a gap between the rotational shaft 1 and the intermediate bracket 50. An example of the shaft sealing device 30 includes a double mechanical seal. The shaft sealing device 30 includes a rotary side seal member (not shown) fixed to the rotational shaft 1, and a stationary side seal member (not shown) fixed to the intermediate bracket 50. Therefore, when the rotational shaft 1 rotates, the rotary side seal member comes into sliding contact with the stationary side seal member, and the shaft sealing device 30 generates heat.

Further, in such pump apparatus, the temperature of the liquid to be handled may range from low temperature (e.g., −25° C.) to high temperature (e.g., 140° C.). For example, when the temperature of the liquid to be handled is higher than an allowable temperature of the shaft sealing device 30, if the hot liquid to be handled directly contacts the shaft sealing device 30, the temperature of the shaft sealing device 30 generated by the sliding heat rises further. In this embodiment, the liquid to be handled includes a slurry liquid containing a slurry of about 0.05 mm. In one embodiment, the liquid to be handled may include clean water or dirty water.

In this manner, the shaft sealing device 30 becomes very hot due to the sliding of the rotary side seal member and the stationary side seal member, and contact with the high-temperature liquid to be handled, and the shaft sealing device 30 may fail. As a result, the shaft sealing device 30 cannot fully exhibit its function, and the liquid may leak to the motor 7 side, and the motor 7 may be submerged in water. Therefore, in the pump apparatus, a structure capable of reliably preventing failure of the shaft sealing device 30 is desired.

The pump apparatus includes a normal temperature flow path 60 that keeps the liquid flowing through the shaft sealing device 30 within a predetermined temperature range. In other words, the pump apparatus includes the normal temperature flow path 60 (second flow path) that keeps the liquid to be handled in the flow path 90 within a predetermined temperature range. The opening 50a forms the flow path 90 (first flow path) through which the liquid to be handled flows into the shaft sealing device 30. In the embodiment, the normal temperature flow path 60 is formed in the intermediate bracket 50. More specifically, the intermediate bracket 50 includes a cover portion 51 covering an opening end 5a of the pump casing 5, and a bracket portion 52 connected to the cover portion 51. The normal temperature flow path 60 is formed in at least one of the cover portion 51 and the bracket portion 52.

The normal temperature flow path 60 is formed in both the cover portion 51 and the bracket portion 52, but in one embodiment, the normal temperature flow path 60 may be formed only in the cover portion 51, or may be formed in the bracket portion 52. That is, the opening 50a is formed at an opening 51a in the cover portion 51 through which the rotational shaft 1 passes and/or the opening 52a in the bracket portion 52 through which the rotational shaft 1 passes. The opening 50a forms the flow path 90, and the normal temperature channel 60 is formed adjacent to at least a portion of the opening 50a so that the liquid to be handled in the flow path 90 can be kept within a predetermined temperature range. The shaft sealing device 30 determines an allowable temperature range according to its product specifications. The predetermined temperature range described as “the liquid to be handled in the flow path 90 can be kept within a predetermined temperature range” means that the temperature of the shaft sealing device 30 is within the allowable range even if the shaft sealing device 30 generates heat due to sliding.

The normal temperature flow path 60 is arranged radially outward of the flow path 90 formed by an outer peripheral surface of the rotational shaft 1 and an inner peripheral surface (opening 50a) of the intermediate bracket 50. The liquid to be handled pressurized by the rotation of the impeller 3 contacts the shaft sealing device 30 after being heat-exchanged by the fluid in the normal temperature flow path 60 separated by a side wall 60a when flowing through the flow path 90. In other words, the liquid to be handled in the flow path 90 that has been brought to an appropriate temperature by the fluid in the normal temperature flow path 60 can be used for lubricating the shaft sealing device 30. Therefore, the shaft sealing device 30 can prevent leakage to the motor 7 side even if the liquid to be handled is out of the allowable range.

The normal temperature flow path 60 communicates with a liquid inlet 61 and a liquid outlet 62. The liquid (e.g., tap water) flows from a liquid supply source (not shown) through the liquid inlet 61 into the normal temperature flow path 60. The normal temperature liquid (e.g., clear water of 0° C. to 65° C.) that has flowed into the normal temperature flow path 60 keeps the temperature of the liquid present in the flow path 90 arranged radially inside the normal temperature flow path 60 within a predetermined range (e.g., 0° C. to 65° C.).

For example, when the temperature of the liquid to be handled is higher than the allowable range of the shaft sealing device 30 (e.g., 140° C.), the high-temperature liquid to be handled is cold by the liquid flowing through the normal temperature flow path 60 (e.g., tap water or industrial water of the normal temperature of 0° C. to 35° C.). Conversely, when the temperature of the liquid to be handled is lower than the allowable range of the shaft sealing device 30 (e.g., minus 25° C.), the low-temperature liquid to be handled is heated by the liquid flowing through the normal flow path 60 (e.g., tap water or industrial water of the normal temperature of 0° C. to 35° C.). Thereby, the temperature of the shaft sealing device 30 can be kept within the allowable range. After that, the liquid that has flowed into the normal temperature flow path 60 is discharged from the liquid outlet 62. The liquid flowing through the normal temperature flow path 60 is an example of a fluid, and examples of the fluid may be tap water, factory water, or gas.

In this manner, clean water (tap water, factory pumped water, etc.), which is easy to handle, is used as a fluid for keeping the temperature of the shaft sealing device 30 within the allowable range while avoiding the shaft sealing device 30 from coming into contact with the liquid to be handled whose temperature is outside the allowable range. In the embodiment, the fluid in the normal temperature flow path 60 used for adjusting the temperature of the shaft sealing device 30 does not mix with the liquid to be handled pressurized by the impeller 3. Therefore, the temperature of the shaft sealing device 30 can be kept within the allowable range by using a fluid different from the liquid to be handled. In other words, a user can select the fluid for the normal temperature flow path 60 depending on an equipment and an environment. Therefore, the pump apparatus of this embodiment is particularly effective when the transferred liquid is a special liquid containing slurry or the like.

Further, it is preferable that the intermediate bracket 50 includes a throttle portion 65 that throttles the flow path of the liquid (i.e., the liquid to be handled) flowing through the shaft sealing device 30. The throttle portion 65 shown in FIG. 1 is a member (e.g., a bush) having an annular shape. The throttle portion 65 is fixed to the inner peripheral surface of the cover portion 51 which is the inlet of the flow path 90, and arranged concentrically with the rotational shaft 1. The throttle portion 65 reduces a flow rate of the liquid to be handled through the flow path 90 by reducing the flow path 90 (i.e., the gap between the throttle portion 65 and the impeller 3) to the shaft sealing device 30. As a result, the time for heat exchange with the fluid in the room temperature flow path 60 is lengthened, and a cooling effect can be expected.

Furthermore, it is preferable that a retaining chamber 66 for liquid flowing to the shaft sealing device 30 is formed between the shaft sealing device 30 and the throttle portion 65. The retaining chamber 66 is an annular chamber formed between an outer peripheral surface of the rotational shaft 1 and the inner peripheral surface of the cover portion 51, and the liquid that has passed through the gap between the throttle portion 65 and the impeller 3 retains in the retaining chamber 66.

During an initial operation of the pump apparatus, the liquid to be handled that has flowed into the pump casing 5 due to the rotation of the impeller 3 passes through the small gap between the impeller 3 and the throttle portion 65, and flows into the retaining chamber 66. The liquid once flowing into the retaining chamber 66 continues to stay in the retaining chamber 66 until the pressure inside the pump casing 5 is sufficiently lowered.

The normal temperature flow path 60 is arranged outside the retaining chamber 66, and the retaining chamber 66 communicates with the shaft sealing device 30. More specifically, the normal temperature flow path 60 is an annular flow path surrounding the retaining chamber 66. Therefore, the liquid existing in the retaining chamber 66 is more actively heat-exchanged with the liquid flowing through the normal temperature flow path 60.

In this manner, the liquid in contact with the shaft sealing device 30 is retained in the retaining chamber 66 for a long time, and heat is exchanged with the liquid flowing through the normal temperature flow path 60. The temperature of the shaft sealing device 30 falls within the allowable range. That is, the liquid to be handled within a predetermined temperature range that allows the temperature of the shaft sealing device 30 to remain in the retaining chamber 66, and the liquid retained in the retaining chamber 66 is used to lubricate the shaft sealing device 30. With such a configuration, the liquid existing in the retaining chamber 66 prevents the contact of the high-temperature or low-temperature liquid outside the predetermined temperature range with the shaft sealing device 30. As a result, the shaft sealing device 30 can be prevented from failing due to contact with the high-temperature or low-temperature liquid.

In this embodiment, the pump apparatus includes the normal temperature flow path 60 that keeps the liquid flowing through the shaft sealing device 30 within a predetermined temperature range, but means for protecting the shaft sealing device 30 is not limited to this embodiment. In one embodiment, the pump apparatus does not need to include at least one of the normal temperature flow path 60, the throttle portion 65, the retaining chamber 66, etc., as long as the shaft sealing device 30 can be protected.

As described above, the pump apparatus is periodically disassembled and cleaned depending on the intended use. During this disassembly and cleaning, it is necessary to completely remove the liquid inside the pump apparatus. However, since an internal flow path of the pump casing 5 has a complicated shape, it is troublesome to remove the remaining liquid.

In particular, in the pump apparatus according to the present embodiment, a slurry liquid is included as the liquid to be handled, and the slurry liquid tends to remain in the pump casing 5 when disassembly and cleaning of the pump apparatus. Therefore, in the embodiment described below, the structure of the pump casing 5, which has a simple structure and can be easily washed, will be described with reference to the drawings.

The pump casing 5 has a suction nozzle 100 with the suction port 12 formed therein. In the pump apparatus, the suction port 12 is flange-connected to a horizontally extending a suction pipe S, and the discharge port 13 is flange-connected to a horizontally extending a discharge pipe D by fasteners (e.g., bolts and nuts). The pump apparatus is operated in that state. The suction nozzle 100 slopes downward toward the suction port 12. More specifically, the pump casing 5 further includes a volute portion 101 to which the suction nozzle 100 is connected, and the suction nozzle 100 slopes downward from the volute portion 101 toward the suction port 12.

The volute portion 101 forms a volute chamber 102 around the impeller 3 housed in the pump casing 5. The transferred liquid pressurized by the impeller 3 in the volute chamber 102 is discharged from the discharge port 13 laterally extending from the volute chamber 102. The suction nozzle 100 is connected to the center of a bottom of the volute portion 101, and extends downward from the volute portion 101.

The suction nozzle 100 includes a connection portion 100a connected to the volute portion 101, a suction flange portion 100b having the suction port 12, and a nozzle portion 100c connected to the connection portion 100a and the suction flange portion 100b. The nozzle portion 100c extends obliquely downward from the connection portion 100a toward the suction flange portion 100b, and the suction port 12 of the suction nozzle 100 is arranged below the connection portion 100a of the suction nozzle 100. That is, the suction port 12 is a bottom portion of the flow path inside the pump casing 5.

Therefore, when the operator stops the pump apparatus, and removes the suction nozzle 100 from the suction pipe S, the liquid in the suction nozzle 100 does not remain in the nozzle portion 100c as indicated by the arrow in FIG. 1, smoothly flows from the flow path on the discharge side of the impeller 3 and the volute portion 101 toward the suction port 12. As a result, when the pump apparatus is disassembled and cleaned, the liquid in the pump casing 5 flows through the downwardly inclined suction nozzle 100, and is discharged to the outside through the suction port 12 without requiring special work.

In this manner, the pump apparatus of this embodiment has a simple structure in which the suction nozzle 100 extends obliquely downward. The pump apparatus can cause the liquid to flow out of the pump casing 5 when the suction-side pipe (suction pipe S) is removed. With such a structure, a drain work for removing the liquid from the pump casing 5 can be simplified, and the operator can disassemble and clean the pump apparatus without much trouble.

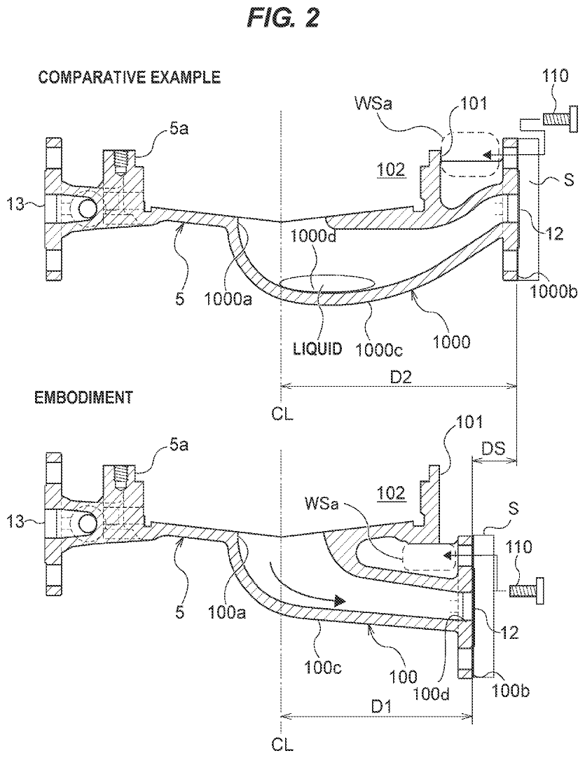

FIG. 2 is a view for explaining an effect of the pump casing 5 including the suction nozzle 100. FIG. 2 shows a suction nozzle 100 (see a lower drawing in FIG. 2) according to the embodiment shown in FIG. 1 and a conventional suction nozzle 1000 (see an upper drawing in FIG. 2) as a comparative example.

As shown in the upper drawing of FIG. 2, the conventional suction nozzle 1000 includes a connection portion 1000a connected to the volute portion 101, and a suction flange portion 1000b having the suction port 12 that is approximately the same height as the discharge port 13, and a U-shaped nozzle portion 1000c connected to the portion 1000a and the suction flange portion 1000b. That is, in the conventional suction nozzle 1000, the suction port 12 and the discharge port 13 have substantially the same height. Therefore, the nozzle portion 1000c extending obliquely downward from the connection portion 1000a is curved obliquely upward, a lowest bottom portion 1000d within the pump casing 5 is formed in the curved portion.

Therefore, when the suction flange portion 1000b is removed from the suction pipe S, the liquid inside the pump casing 5 may remain on the bottom portion 1000d. In other words, in order to completely remove the liquid in the pump casing 5 at the suction nozzle 1000 shown in the comparative example, it is necessary for the operator to perform the draining work shown in the example below.

(1) Draining work for blowing off the liquid remaining at the bottom 1000d by jetting high-pressure gas.

(2) Draining work by tilting the pump casing 5 and lowering the suction port 12 below the bottom 1000d.

(3) Draining work using another device (e.g., pump apparatus, tool, etc.).

In the embodiment, the nozzle portion 100c has a linear shape extending obliquely downward from the connection portion 1000a, so that the suction port 12 is a lowest bottom portion 100d of the flow path in the pump casing 5. Therefore, when the suction pipe S is removed from the suction flange portion 100b, the liquid in the pump casing 5 is discharged outside through the suction port 12, which is the bottom portion 100d, by the action of gravity, and hardly remains in the nozzle portion 100c. As a result, the above-described draining work can be omitted, and a cleaning work in the pump casing 5 can be simplified.

In the embodiment of lower side of FIG. 2, the suction nozzle 100 (more specifically, the nozzle portion 100c) extends obliquely downward in a straight line from the connection portion 100a to the suction port 12. Therefore, the operator can easily see the inside of the suction nozzle 100 through the suction port 12. As a result, the operator can easily inspect the inside of the suction nozzle 100 (e.g., whether there is residue).

In the comparative example, the upper portion of the suction flange portion 1000b is arranged side by side with the volute portion 101. Therefore, the suction nozzle 1000 extends outward such that a working space WSa is formed between the volute portion 101 and the suction flange portion 1000b. The work space WSa is a space necessary for a work of a flange-connecting the pump apparatus and the suction pipe S by means of a fastener (e.g., a bolt and nut combination) 110.

Since the suction flange portion 100b of the suction nozzle 100 of the embodiment is arranged at a position lower than the volute portion 101, the work space WSa can be formed between the volute portion 101 and the nozzle portion 100c.

In the suction nozzle 100, the work space WSa can be secured below the volute portion 101 as well. With such a structure, a distance D1 between a center line CL of the pump apparatus and the suction flange portion 100b can be made smaller by a difference DS than a distance D2 between the center line CL of the pump apparatus and the suction flange portion 1000b. In this embodiment, the length of the suction nozzle 100 extending outward from the volute portion 101 can be shortened as compared with the comparative example. Therefore, the pump apparatus including the suction nozzle 100 according to the embodiment can be compact in overall size.

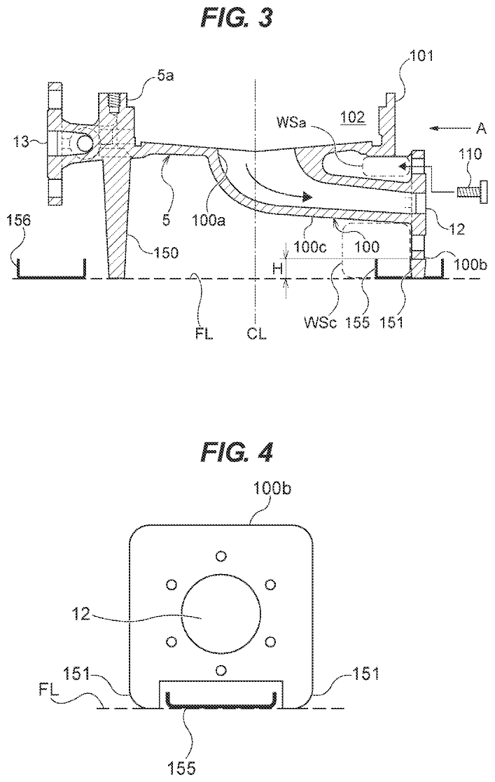

FIG. 3 is a view showing another embodiment of the pump apparatus. In the embodiment shown in FIG. 3 the pump apparatus includes leg portions 150 and 151 connected to the pump casing 5. By providing the leg portions 150 and 151, the pump apparatus can stand on its own, so that the operator can easily carry the pump apparatus.

Furthermore, it is preferable that the leg portions 150 and 151 form a space having a height H between the suction flange portion 100b and the floor FL. By forming the space of the height H, a drain pan 155 for collecting waste liquid can be arranged directly below the suction flange portion 100b. As shown in FIG. 3, a drain pan 156 may be arranged directly below the discharge port 13. It is possible to easily collect a waste liquid that flows out when the pipe is removed.

FIG. 4 is a view seen from a direction of a line A in FIG. 3. In FIG. 4, the suction flange portion 100b has a ground plane, and the two leg portions 151 are formed at the ground plane of the suction flange portion 100b. The suction flange portion 100b and the leg portion 151 are integrally molded member. The drain pan 155 is arranged between two leg portions 151 adjacent to each other. In the embodiment, the suction flange portion 100b is not limited to the shape shown in the drawing as long as it has a ground surface. Any shape may be used as long as it can be flange-connected to the suction pipe S.

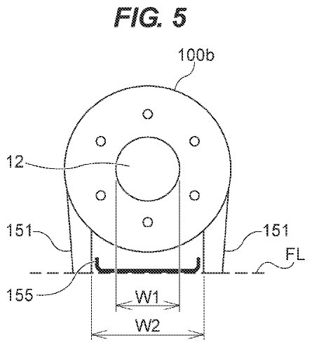

FIG. 5 is a view showing another embodiment of the suction flange portion 100b. In the embodiment shown in FIG. 5, the suction flange 100b has a circular shape, and the two leg portions 151 extend downward from the bottom of the suction flange 100b. As shown in FIG. 5, in order to arrange the drain pan 155 below the suction port 12, the distance W2 between the leg portions 151 adjacent to each other is greater than the diameter W1 of the suction port 12 (W2>W1). With such a configuration, the drain pan 155 is arranged below the suction port 12, and the two leg portions 151 are arranged on both sides of the drain pan 155.

By removing the suction pipe from the suction nozzle 100, the liquid in the suction nozzle 100 flows from the volute portion 101 toward the suction port 12 and out of the suction port 12 by the action of gravity without remaining in the nozzle portion 100c. The drain pan 155 arranged directly below the suction flange portion 100b can receive the liquid flowing out from the suction port 12.

Since the suction port 12 is the lowest bottom portion 100d of the flow path in the pump casing 5, the bottom portion of the suction flange portion 100b is arranged at the lowest position in the pump apparatus. Therefore, as shown in FIGS. 4 and 5, the suction flange portion 100b and the leg portion 151 can be easily used together. By providing the leg portions 150 and 151, a work space WSc can be formed below the suction flange portion 100b. The work space WSc is a space for connecting the suction nozzle 100 to the suction pipe with the fastener 110. By forming the work space WSc, the operator can easily attach and detach the suction nozzle 100 and the suction pipe.

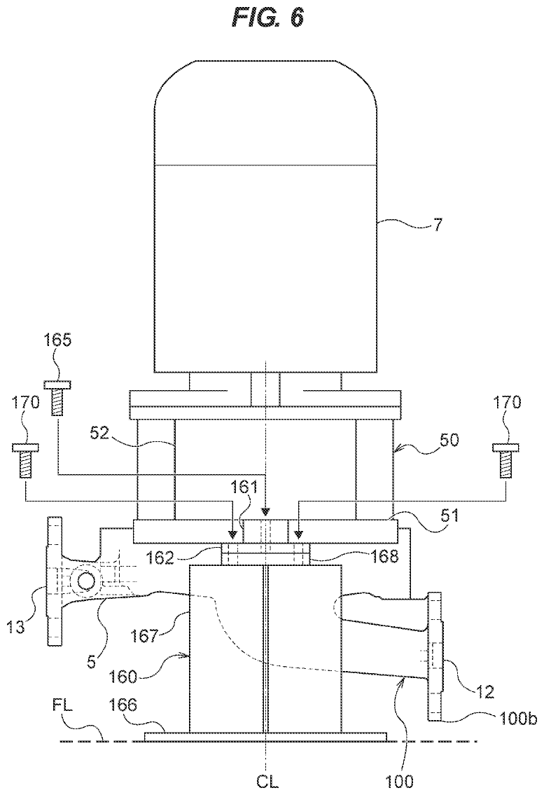

FIG. 6 is a view showing another embodiment of the leg portion. As shown in FIG. 6, instead of the leg portions 150 and 151, the pump apparatus may also include a leg portion 160 connected to the intermediate bracket 50 via the pump casing 5. In the embodiment shown in FIG. 6, a protrusion 161 projecting outward from the cover portion 51 is formed on the cover portion 51 of the intermediate bracket 50. Similarly, a protrusion 162 projecting outside from the pump casing 5 is formed on the pump casing 5. The protrusion 161 of the cover portion 51 and the protrusion 162 of the pump casing 5 are coupled to each other by fasteners (e.g., bolts) 165.

The leg portion 160 includes a base portion 166, a wall portion 167 extending vertically from the base portion 166, and a connection portion 168 fixed to the wall portion 167 and connectable to the protrusion 162 of the pump casing 5. The protrusion 162 and the connection portion 168 are connected to each other by fasteners (e.g., bolts) 170.

With such a configuration, the intermediate bracket 50 and the pump casing 5 are connected to each other by the fasteners 165, and the pump casing 5 and the leg portion 160 are connected to each other by fasteners 170. Also in the embodiment shown in FIG. 6, by providing the leg portion 160, the drain pans 155 and 156 (see FIG. 3) can be arranged below the pump casing 5, and the work space WSc (see FIG. 3) for connecting the suction nozzle 100 to the suction pipe can be secured.

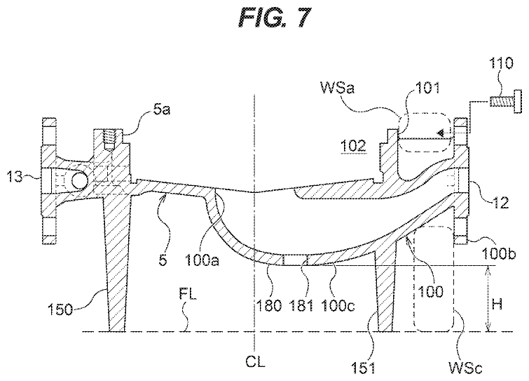

FIG. 7 is a view showing another embodiment of the suction nozzle 100. In the embodiment shown in FIG. 7, the pump apparatus also includes the leg portions 150 and 151. In the embodiment shown in FIG. 7, the suction nozzle 100 includes a U-shaped nozzle portion 100c. As shown in FIG. 7, the nozzle portion 100c has a drain port 181 at its bottom portion 180. The drain port 181 is a through hole for discharging the liquid inside the nozzle portion 100c to the outside. Normally, the drain port 181 is closed with a lid (not shown) during operation of the pump apparatus. When disassembling and cleaning the pump casing 5, the lid is removed and the liquid inside the pump casing 5 is drained through the drain port 181.

In the embodiment shown in FIG. 7, the leg portions 150 and 151 form a space of the height H between the bottom portion 180 of the nozzle portion 100c and the floor FL. By forming a space of the height H, when the liquid is discharged, a drain pan (not shown) can be arranged directly below the drain port 181 or a drain pipe can be connected to the drain port 181.

Furthermore, by providing the leg portions 150 and 151, it is possible to achieve the effect of making the pump apparatus easier to carry and the effect of being able to form the working space WSc below the suction flange portion 100b.

The pump apparatus according to the embodiment described above is a vertical pump apparatus capable of transferring the liquid (i.e., slurry liquid) containing slurry (i.e., light slurry) of about 0.05 mm. The impeller 3 is preferably a semi-open impeller for transferring the slurry liquid. By adopting the semi-open impeller, it is possible to suppress the slurry from being caught between the pump casing 5 and the impeller 3. Furthermore, the pump apparatus includes the impeller 3 having a larger diameter than that of a general impeller in order to obtain a large head relative to the flow rate, and rotates the rotational shaft 1 at a low speed (e.g., 1500 min−1).

With such a structure, the suction pressure of the pump increases, and as a result, a large thrust force that pushes the impeller 3 upward (i.e., toward the cover portion 51) is generated. If the size of the gap between the impeller 3 and the cover portion 51 changes due to this thrust force, there is a risk that the pump apparatus will not be able to exhibit the desired performance, or that the slurry will be trapped to the gap between the impeller 3 and the cover portion 51. Therefore, in the embodiment described below, the pump apparatus has a structure capable of restricting the upward movement of the impeller 3 even if the large thrust force is generated.

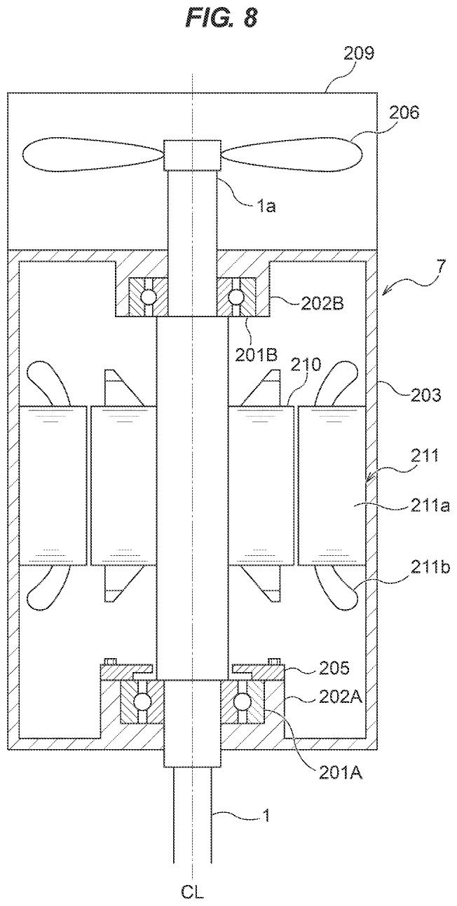

FIG. 8 is a view showing one embodiment of the motor 7. As shown in FIG. 8, the motor 7 includes a first bearing 201A and a second bearing 201B that rotatably support the rotational shaft 1, a motor casing 203 having a first bearing support portion 202A and a second bearing support portion 202B that support the first bearing 201A and the second bearing 201B, and a bearing retainer 205 for restricting a movement of the first bearing 201A in the direction of the axis CL of the rotational shaft 1.

The rotational shaft 1 extends through the motor casing 203, and a cooling fan 206 is fixed to an end portion 1a of the rotational shaft 1. The cooling fan 206 is housed in a fan cover 209 connected to the motor casing 203. The second bearing 201B is an anti-load side bearing arranged adjacent to the cooling fan 206. The first bearing 201A is a load side bearing spaced apart from the cooling fan 206.

A rotor 210 and a stator 211 for rotating the rotational shaft 1 are arranged between the first bearing 201A and the second bearing 201B. The rotor 210 is fixed to the rotational shaft 1, and the stator 211 surrounds the rotor 210, and in the stator 211, a winding (coil) 211b receives the electric power to form a rotating magnetic field. The stator 211 includes a stator core 211a, and a plurality of windings 211b wound around the stator core 211a. The rotor 210 is rotated by the rotating magnetic field formed between the rotor 210 and the stator 211, and the rotational shaft 1 to which the rotor 210 is fixed rotates together with the rotor 210.

The first bearing 201A is supported by the first bearing support portion 202A, and the second bearing 201B is supported by the second bearing support portion 202B. As described above, when the thrust force that pushes up the impeller 3 is generated, the thrust force acts on the first bearing 201A and the second bearing 201B through the rotational shaft 1. The thrust force acting on the second bearing 201B is received by the second bearing support portion 202B, while the thrust force acting on the first bearing 201A is not received by the first bearing support portion 202A. Therefore, the motor 7 includes the bearing retainer 205 that receives the thrust force acting on the first bearing 201A.

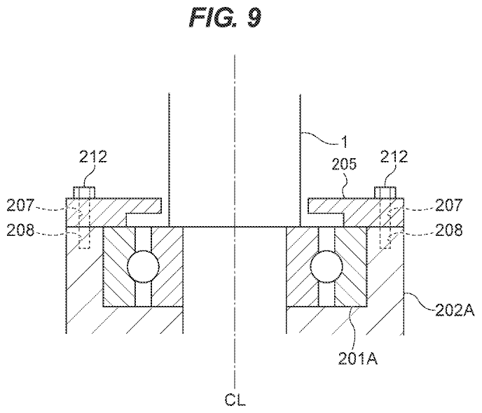

FIG. 9 is a view showing the bearing retainer 205. As shown in FIG. 9, the bearing retainer 205 is fixed to the first bearing support portion 202A by a plurality of fasteners 212. The bearing retainer 205 has an annular shape, and is arranged concentrically with the rotational shaft 1. The fasteners 212 are preferably arranged at regular intervals along the circumferential direction of the bearing retainer 205. The bearing retainer 205 has a through hole 207 into which the fastener 212 can be inserted. The first bearing support portion 202A has a fastening hole 208 into which the fastener 212 can be inserted. By inserting the fastener 212 into the through hole 207 and the fastening hole 208 and tightening the fastener 212, the bearing retainer 205 is fixed to the first bearing support portion 202A.

According to this embodiment, the bearing retainer 205 can reliably receive the thrust force acting on the first bearing 201A. Therefore, the pump apparatus can maintain a desired size of the gap between the impeller 3 and the cover portion 51 even if a large upward thrust force is generated in the impeller 3.

As described above, the pump apparatus is capable of pumping the slurry liquid, including the light slurry. If the slurry liquid is continuously transferred, the components (the impeller 3, the pump casing 5, and the cover portion 51, etc.) of the pump apparatus that come into contact with the slurry liquid may be worn. This wear changes the size of the gap between the impeller 3 and its peripheral members (e.g., the pump casing 5 and the cover portion 51), which may adversely affect the performance of the pump apparatus. Furthermore, the pump apparatus is capable of transferring hot liquids to be handled. In this case, the components of the pump apparatus thermally expand under the influence of the heat of the liquid to be handled, and as a result, there is a risk that the size of the gap between the impeller 3 and its peripheral members will change. Therefore, in the embodiments described below, the pump apparatus includes a gap adjustment structure for adjusting the size of the gap.

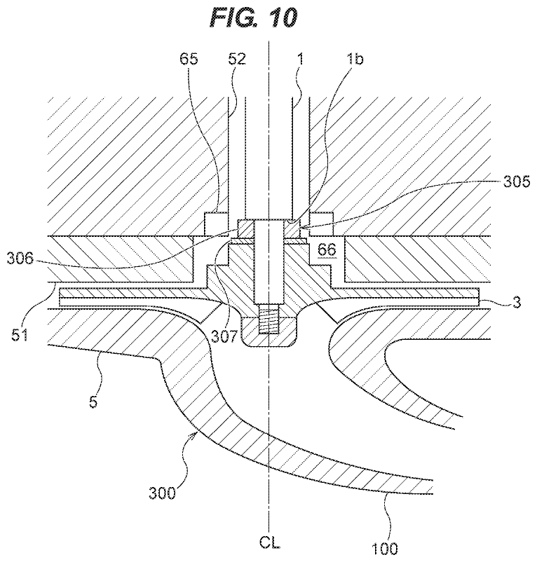

FIG. 10 is a view showing the gap adjustment structure. In the embodiments described below, peripheral members of the impeller 3 (e.g., the pump casing 5 and the cover portion 51) may be collectively referred to as an impeller housing structure 300. As shown in FIG. 10, the pump apparatus includes the impeller housing structure 300 housing the impeller 3, and a gap adjustment structure 305 for adjusting the size of the gap between the impeller 3 and the impeller housing structure 300.

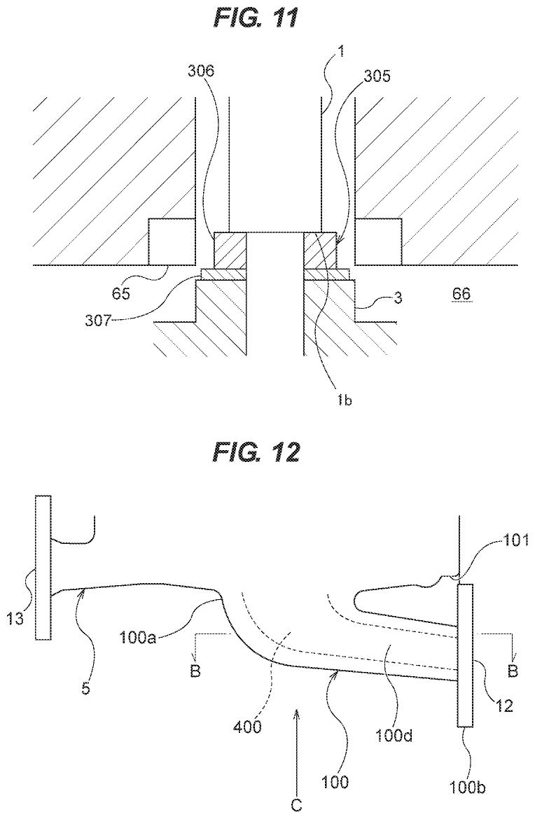

FIG. 11 is an enlarged view of the gap adjustment structure 305. As shown in FIG. 11, the gap adjustment structure 305 includes a distance piece 306 attached to a stepped portion 1b of the rotational shaft 1, and at least one shim 307 arranged between the distance piece 306 and the impeller 3.

Each of the distance piece 306 and the shim 307 has an annular shape, and is arranged concentrically with rotational shaft 1. The shim 307 has a minute thickness (e.g., 0.1 mm). The operator adjusts the size of the gap between the impeller 3 and the impeller housing structure 300 by arranging one or more shims 307 with the distance piece 306 attached.

When transferring a high-temperature liquid to be handled, the operator considers the thermal expansion of the impeller 3 and the impeller housing structure 300, and determines the number of shims 307 to be arranged. According to this embodiment, the size of the gap between the impeller 3 and the impeller housing structure 300 can be freely adjusted by a simple method of adjusting the number of shims 307. In particular, in the embodiment, the pump apparatus has a structure in which the impeller 3 is directly fixed to the rotational shaft 1 extending from the motor 7. Therefore, it is particularly effective to provide the gap adjustment structure 305 that allows the gap to be adjusted without requiring a complex structure.

According to the embodiment, even if the impeller 3 and the impeller housing structure 300 are worn due to transfer the slurry liquid, the operator adds the shim 307 during maintenance of the pump apparatus. Thereby, the size of the gap between the impeller 3 and the impeller housing structure 300 can be adjusted to an appropriate size. Therefore, the cost of the pump apparatus can be reduced.

According to the embodiment, the pump apparatus does not need to have a special structure for transferring the slurry liquid by including the gap adjustment structure 305, and can also transfer the liquid to be handled such as clean water. More specifically, the operator may remove the gap adjustment structure 305 when transferring the liquid to be handled such as clear water, and may attach the gap adjustment structure 305 when transferring the slurry liquid.

FIG. 12 is a view showing another embodiment of the pump apparatus. As shown in FIG. 12, the suction nozzle 100 slopes downward from the volute portion 101 toward the suction port 12. With such a structure, a length of the suction nozzle 100 extending outward from the volute portion 101 can be shortened, and as a result, the overall size of the pump apparatus can be made compact (see FIG. 2).

In order to make the size of the pump apparatus compact, the size of the suction nozzle 100 in the height direction is reduced, and the width direction (more specifically, a direction from the centerline CL of the pump apparatus to the suction flange 100b) of the suction nozzle 100 is desirable. Also, it is important to minimize the change in the shape of the suction nozzle 100 and increase a cross-sectional area (cross-sectional area in the height direction) of the flow path of the suction nozzle 100 at a constant rate of change. This is because the pump casing 5 generally causes problems such as cavitation when the flow rate on the suction side is largely throttled. Therefore, it is desirable that the suction nozzle 100 has a shape that suppresses pressure loss while ensuring a predetermined cross-sectional area in the flow path.

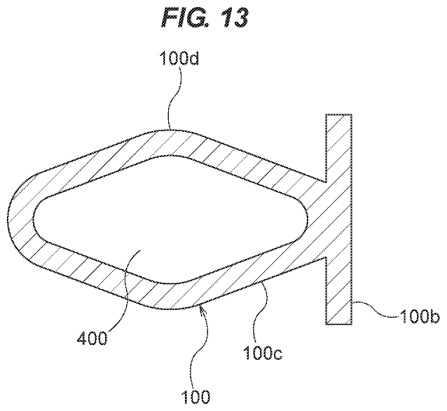

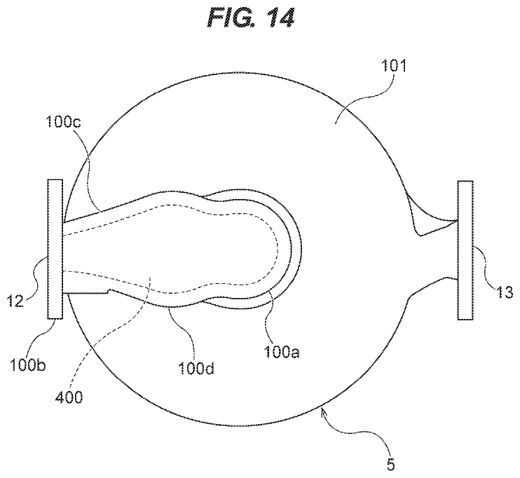

FIG. 13 is a cross-sectional view taken along a line B-B of FIG. 12. FIG. 14 is a view seen from a direction of a line C in FIG. 12. As shown in FIGS. 13 and 14, the suction nozzle 100 has a flow path 400 that slopes downward from the volute portion 101 (more specifically, a connection portion 100a connected to the volute portion 101) toward the suction port 12, and a wide portion 100d arranged between the suction port 12 and the connection portion 100a so that the cross-sectional area of the flow path 400 increases at a constant rate of change from the suction port 12 toward the connection portion 100a.

The wide portion 100d extends horizontally in order to reduce the size of the suction nozzle 100 in the height direction, and realize a compact pump apparatus. The flow rate of the liquid to be handled in the wide portion 100d increases. Therefore, by providing the wide portion 100d, the suction nozzle 100 can increase the cross-sectional area of the flow path 400 at a constant rate of change. As a result, the pump apparatus can ensure the necessary flow rate while preventing cavitation from occurring. Furthermore, the suction nozzle 100 can be tilted at an optimum angle to reduce pressure loss.

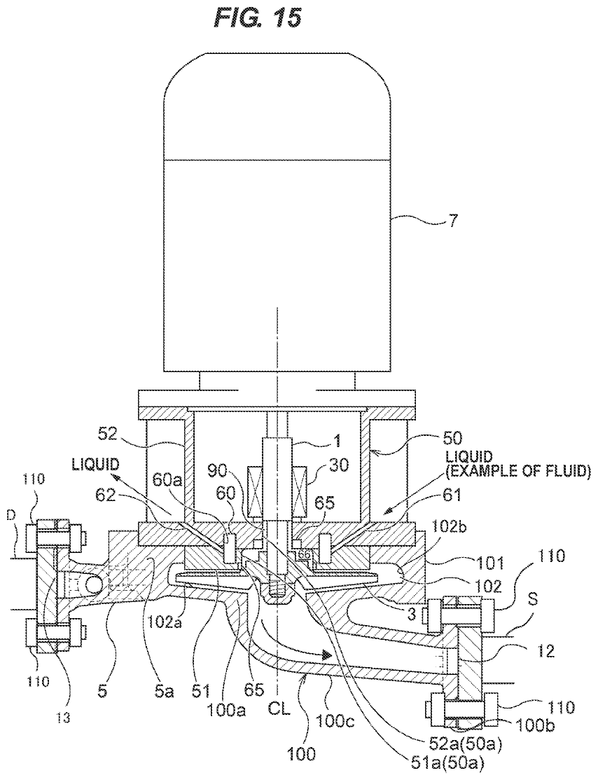

FIG. 15 is a view showing another embodiment of the pump casing. As shown in FIG. 15, the pump casing 5 may have a drain structure. More specifically, the volute portion 101 of the pump casing 5 has the volute chamber 102 in which the impeller 3 is housed. The volute chamber 102 has a bottom surface 102a arranged below the impeller 3, and an outer peripheral portion 102b arranged outside the impeller 3. The bottom surface 102a of the volute chamber 102 slopes downward from the outer peripheral portion 102b of the volute chamber 102 toward the connection portion 100a.

By forming the bottom surface 102a, the liquid to be handled that remains in the volute chamber 102 after stopping the operation of the pump apparatus flows down the bottom surface 102a due to the action of gravity, and is smoothly discharged from the volute chamber 102. In the embodiment shown in FIG. 15, the suction nozzle 100 is sloped downward toward the suction portion 12. Therefore, the liquid to be handled discharged from the volute chamber 102 flows down the nozzle portion 100c, which extends diagonally downward from the connection portion 100a to the suction flange portion 100b, and is smoothly discharged from the suction port 12.

As shown in FIG. 15, the suction port 12 is arranged at a position lower than the discharge port 13, and is arranged on the side of the suction flange portion 100b. Therefore, the liquid to be handled remaining in the volute chamber 102 is reliably directed to the suction nozzle 100 without flowing to the discharge port 13 side.

Although the drain structure applied to the pump casing 5 according to the embodiment shown in FIG. 1 has been described in the embodiment shown in FIG. 15, such a drain structure can also be applied to the pump casing 5 according to the embodiment shown in FIG. 12.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a pump casing and a pump apparatus.

### REFERENCE SIGNS LIST

1 rotational shaft
1a end portion
1b stepped portion
3 impeller
5 pump casing
5a opening end
7 motor
12 suction port
13 discharge port
30 shaft sealing device
50 intermediate bracket
50a opening
51 cover portion
51a opening
52 bracket portion
52a opening
60 normal temperature flow path (second flow path)
60a side wall
61 liquid inlet
62 liquid outlet
65 throttle portion
90 flow path (first flow path)
100 suction nozzle
100a connection portion
100b flange portion
100c nozzle portion
100d wide portion
101 volute portion
102 volute chamber
102a bottom surface
102b outer peripheral surface
150,151 leg portion
155,156 drain pan
160 leg portion
161,162 protrusion
165 fastener
166 base portion
167 wall portion
168 connection portion
170 fastener
180 bottom portion
181 drain port
201A first bearing
201B second bearing
202A first bearing support portion
202B second bearing support portion
203 motor casing
205 bearing retainer
206 cooling fan
207 through hole
208 fastening hole
209 fan cover
210 rotor
211 stator
211a stator core
211b winding
212 fastener
300 impeller housing structure
305 gap adjustment structure
306 distance piece
307 shim
400 flow path
1000 suction nozzle
1000a connection portion
1000b flange portion
1000c nozzle portion

1-23. (canceled)

24. A pump casing comprising:
a suction nozzle having a suction port; and
a volute portion connected to a connection portion of the suction nozzle, and the volute portion having a volute chamber,
wherein a bottom surface of the volute chamber slopes downward from a peripheral portion of the volute chamber toward the connection portion.

25. The pump casing according to claim 24, wherein the suction nozzle slopes downward from the connection portion toward the suction port.

26. The pump casing according to claim 24, wherein the suction port is arranged at a position lower than a discharge port of the pump casing.

27. The pump casing according to claim 24, wherein the suction port is arranged below the volute portion, and
wherein a work space for connecting the suction nozzle to the suction pipe is formed between the volute portion and the suction nozzle.

28. The pump casing according to claim 24, wherein the suction nozzle having a drain port at a bottom portion of the suction nozzle.

29. A pump apparatus comprising:
an impeller;
a rotational shaft fixing to the impeller;
a motor configured to rotate the rotational shaft; and
a pump casing according to claim 24, the pump casing housing the impeller.

30. The pump apparatus according to claim 29, comprising a leg portion connected to the pump casing.

31. The pump apparatus according to claim 30, wherein the leg portion forms a space below a suction flange portion having the suction port, the space arranging a drain pan configured to catch a liquid discharged from the suction port.

32. The pump apparatus according to claim 31, wherein the pump casing comprises a suction nozzle with formed the suction port,
wherein the suction nozzle has a drain port at a bottom portion of the suction nozzle, and
wherein the leg portion forms a space below the drain port, the space arranging a drain pan configured to catch the liquid discharged from the suction port.

33. The pump apparatus according to claim 30, wherein the pump casing comprises a suction nozzle with formed the suction port,
wherein the suction nozzle has a drain port at a bottom portion of the suction nozzle, and
wherein the leg portion forms a space arranging a pipe connectable to the drain port.
